(19) United States
(12) Patent Application Publication
(10) Pub. No.: US 2017/0337589 A1
(43) Pub. Date: Nov. 23, 2017

(54) CROSS DEVICE IDENTITY MATCHING FOR ONLINE ADVERTISING

(71) Applicant: Yintao Yu, Fremont, CA (US)

(72) Inventor: Yintao Yu, Fremont, CA (US)

(21) Appl. No.: 15/522,281

(22) PCT Filed: Oct. 27, 2015
(86) PCT No.: PCT/IB15/02204

§ 371 Date: Apr. 26, 2017

Related U.S. Application Data
(60) Provisional application No. 62/069,161, filed on Oct. 27, 2014.

(51) Int. Cl. G06Q 30/02

(52) U.S. Cl. CPC G06Q 30/0277; G06Q 30/0269; G06Q 30/0275

(57) ABSTRACT

A system and method for providing cross device identity matching service is provided. An request is received by an ad exchange, which includes an ad impression opportunity and information of one identity associated with a user. The user is determined and at least one identity of the same user is selected for at least one bidder to generate at least one bidding request for online advertising.

### CROSS REFERENCE TO RELATED APPLICATIONS

This application claims priority benefit of U.S. Provisional Patent Application No. 62/069,161, entitled “CROSS DEVICE IDENTITY MATCHING FOR ONLINE ADVERTISING,” filed on Oct. 27, 2014, by Yintao Yu, which is incorporated herein by reference.

### TECHNICAL FIELD

The disclosure relates generally to the field of online advertising.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The development of real-time bidding has tremendously changed how online adverting works. In the recent years, with the popularity of mobile devices such as iPhone and Android devices, more and more advertising (ad) inventories are on mobile. There are also new ad exchanges dedicated to mobile ad inventories. However, the lack of data on mobile devices (such as iPhone, iPad, Android devices) is still a key problem for real-time bidding on mobile. On desktop devices (such as PC, laptop, Mac™, MacBook™ etc.), with the tracking technologies using cookies and tracking pixels, the bidders (commonly known as Demand Side Platform, or DSP) know a lot of data for each user, such as each user's browsing histories. With these rich and valuable data known, the bidders can not only make good guesses of each user's demographic information (such as gender, age bucket, etc.), but can also learn each user's interests, purchasing intentions, etc. These data plays a key role for the bidders to do accurate predictions (click-through rate, conversion rate, etc.) and carefully decide how much they will bid for any impression opportunity. These data also allows the bidders to know who are the retargeting users, and bid accordingly. However, the lack of data on mobile devices makes the bidders unable to learn each user's demographic information and interests accurately on mobile. With insufficient data, the bidders also cannot do accurate predictions (click-though rate, conversion rate), cannot bid with confidence, and can barely do retargeting on mobile.

On the other hand, for each user, even if there is already some amount of data on mobile that is tracked and known to the bidders, such data may be still not as comprehensive as the data collected for the same user on desktop (or the other way around if the user mainly uses mobile device). It is noted that, from the perspective of the bidders, the data tracked for “a user on desktop” and the data tracked for “a user on mobile” are treated as two different users, even if they actually belong to the same physical person. Currently, there is no way or little way for the bidders to know that a certain user on a mobile device is actually the same user tracked under a different user profile on a desktop device, and vice versa. Or more generally, there is no way or little way for the bidders to link the identities of the users across multiple devices, which leads to many inefficiencies.

### SUMMARY

Described embodiments include at least linking the identities of the users across multiple devices (e.g., across desktop devices and mobile devices). Such service allows the bidders to be able to utilize the data of a user on one device to bid on the same user's ad impressions on a different device. For example, cross device linking of identities allows the bidders to utilize the desktop data of a user to bid on the user's ad impressions on mobile; and vice versa, the bidders are also allowed to utilize the mobile data of a user to bid on the user's ad impressions on desktop. Such service may also allow the joint of the data across multiple devices for the same user. As a result, such service allows the bidders to do cross device targeting (including retargeting), and thus the bidders' prediction accuracies (e.g. click-through rate, conversion rate) are enhanced, with more data across different devices available.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

Any of the embodiments in this specification may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE DRAWINGS

FIG. 1 is a block diagram illustrating a real-time bidding eco-system.

FIG. 2 is a block diagram illustrating a real-time bidding eco-system, with the addition of the cross device identity matching service entity, according to one embodiment.

FIG. 3 is a block diagram illustrating a real-time bidding eco-system, with the addition of the cross device identity matching service entity, according to another embodiment.

FIG. 4 is a block diagram illustrating a real-time bidding eco-system, with the addition of the cross device identity matching service entity, according to anther embodiment.

FIG. 5 is a block diagram illustrating a real-time bidding eco-system, with the addition of the cross device identity matching service entity, according to anther embodiment.

FIG. 6 is a block diagram illustrating a real-time bidding eco-system, with the addition of the cross device identity matching service module, according to anther embodiment.

FIG. 7 is a block diagram illustrating a real-time bidding eco-system, with the addition of the cross device identity matching service module, according to anther embodiment.

FIG. 8 is a block diagram illustrating a real-time bidding eco-system, with the addition of the cross device identity matching service module, according to anther embodiment.

FIG. 9 is a block diagrams illustrating how a cross device identity matching service identifies its unique and uniform user ID across multiple devices, according to one embodiment.

FIG. 10 illustrates an example of ID synchronizations of a match table.

FIGS. 11, 12, and 13 show flowcharts of embodiments of methods of online advertising using the cross device identity matching service.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

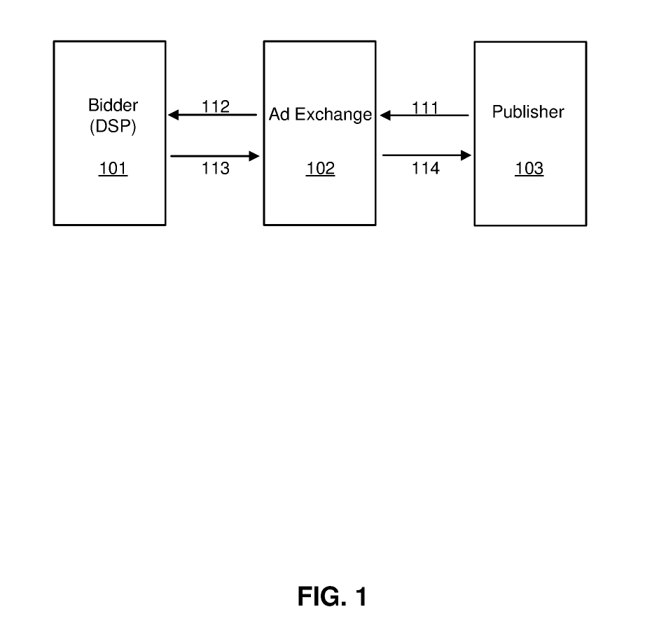

FIG. 1 is a block diagram illustrating a conventional real-time bidding eco-system. Only one bidder 101, one ad exchange 102, and one publisher 103 are shown in FIG. 1 to simplify and clarify the description. Implementations of the real-time bidding eco-system can have multiple bidders, multiple ad exchanges, and multiple publishers. Likewise, the functions performed by the various entities of FIG. 1 may differ in different embodiments.

In FIG. 1, first, when a user visits or uses a publisher 103, a request 111 is sent from the publisher 103 to the ad exchange 102, telling the ad exchange 102 that there is one (or multiple) ad impression opportunity. The publisher 103 can be a website, a blog, a desktop application, a mobile app, etc. The request from the publisher 103 to the ad exchange 102 can be indirect. For example, a blog can use an ad network (e.g. Google AdSense™), and when the blog's webpage is loaded, the ad network portion of the webpage is requested by the user's browser, sending a request to the ad network. The request to the ad network is then routed to an ad exchange (e.g. Google AdX™). In another example, the publisher is a premium publisher (e.g. wsj.com, Wall Street Journal), and it connects to a Supply Side Platform, SSP (not shown in FIG. 1 for simplicity) first, and then the SSP sends the ad impression opportunity to multiple ad exchanges (possibly also to some bidders directly). Thus, the request is sent from the publisher to an SSP first, and then to ad exchanges indirectly. In yet another example, the publisher is a mobile app (e.g. Draw Something, a weather app, etc.) and it uses an SDK (software development kit) provided by an ad exchange (e.g. MoPub), so that when the app is used, a request will be sent to the ad exchange.

Once the ad exchange 102 receives the ad impression opportunity request 111, it sends the request 112 to a number of bidders 101 (commonly known as Demand Side Platform, DSP) to ask the bidders 101 whether they want to bid on this ad impression opportunity, and if so how much they want to bid. The bidders 101 send responses 113 to the ad exchange 102 with how much they want to bid within a fraction of a second, and the ad exchange 102 runs an auction to decide which bidder wins the ad impression and let the publisher 103 to display the corresponding ad 114. There can be an extra ad serving entity (not shown in FIG. 1 for simplicity), which hosts the ad's creative (image, video, etc.) and provides tracking functionality. The ad serving entity can be a module within a bidder or a module with in an ad exchange (if the bidder uploads the creatives to an ad exchange beforehand).

In one example with retargeting on the same device, a user visited NORDSTROM.com and browsed a jacket (didn't buy or finish the transaction). Later, when the same user uses the same browser to visit a publisher 103, e.g. CNN.com, an ad impression opportunity request is sent 111 to an ad exchange 102. The ad exchange 102 then sends requests 112 to a number of bidders 101 to ask them if they want to bid on this user's ad impression at CNN.com. One of the bidders (e.g. TellApart™) bids on behalf of NORDSTROM.com, and this bidder knows the data that the same user has visited NORDSTROM.com on the same device earlier and was interested in a jacket. This bidder thus bids a relative high price on this ad impression opportunity 113 and wins the auction, and an ad with Nordstrom text and the jacket's image will be shown on CNN.com to the user 114. If the user clicks on the ad, it will bring the user to the product page of the jacket on NORDSTROM.com, with the hope that the user will finish the transaction this time.

It is noted that in this disclosure, “device” can refer to any electronic device, bigger or smaller, including laptop, desktop, PC, Mac, smart phones such as iPhone, Android phone, Windows Mobile Phone, Blackberry Phone, etc., tablets such as iPad, Android tablet, etc., and so on. Throughout the specification, the terms “device” and “computing device” are interchangeable to obtain different embodiments.

In another example in which the user switch between different devices but cross device retargeting is not performed, a user visited NORDSTROM.com and browsed a jacket (didn't buy or finish the transaction) on his/her laptop PC. Later, when the same user uses a mobile app (publisher, 103), e.g. DrawSomething, on his/her mobile phone, an ad impression opportunity request is sent 111 to a mobile ad exchange 102. The mobile ad exchange then sends requests 112 to a number of bidders 101. It is noted that the identity information that contained in the request is either the exchange ID, or bidder ID (aka DSP ID, for example, TellApart ID, Turn ID, MediaMath ID, etc.) if the exchange maintains the match table of bidder ID and exchange ID. In an embodiment, the ID associated with the user when browsing on the PC and the ID received from the mobile ad exchange when the user uses a mobile app are different, although both belong to the same user. Thus, the bidders, when receiving the ID from the mobile ad exchange, could not know that the user who uses the mobile app is the same user who has previously visited NORDSTROM.com on the PC. Take one bidder TellApart as an example: for TellApart, which has a client relationship with NORDSTROM and bids on behalf of NORDSTROM, TellApart has tracking pixels at NORDSTROM.com so that TellApart does know there was a user who visited NORDSTROM.com on PC and browsed a jacket. But TellApart does not know and cannot know that the user who uses the mobile app (e.g. DrawSomething) on the mobile device is the same user who visited NORDSTROM.com earlier on PC. From the perspective of TellApart, the user who visited NORDSTROM.com earlier and the user who uses Draw Something have two different TellApart IDs and thus may be two different users. The data of this user on desktop (e.g. the browsing history to a jacket on Nordstrom.com) is stuck on the desktop, and cannot be used for the user's ad impressions on mobile, and vice versa. In this example, TellApart may still know some or certain amount of mobile data of this user such as other apps this user used on this mobile device, but such data is limited to the user's behaviors happened on this mobile device, nothing else for the same user on other devices. Merely based on such limited data on this mobile device, TellApart try to make their best guess of the click-through rate/conversion rate, and decide whether they want to bid on this impression opportunity and how much they want to bid 113. In an embodiment, bidding on an ad impression opportunity based on data of the user on a single device, the bidders may have a low confidence of accurate prediction about which advertisement interests the user.

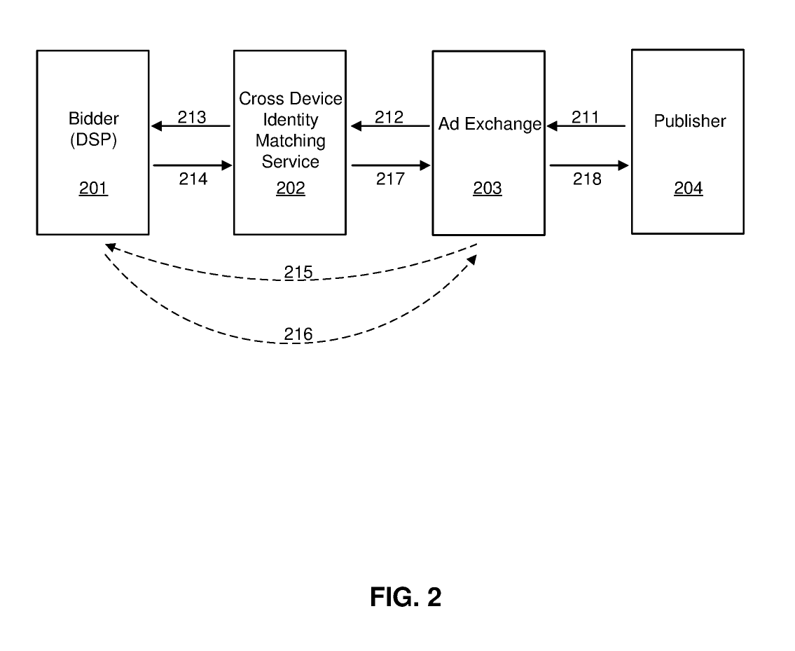

FIG. 2 is a block diagram illustrating a real-time bidding eco-system, with the addition of cross device identity matching service entity. Similar to FIG. 1, only one bidder 201, one cross device identity matching service 202, one ad exchange 203, and one publisher 204 are shown in FIG. 2 to simplify and clarify the description. Implementations of the eco-system can have multiple bidders, multiple cross device identity matching services, multiple ad exchanges, and multiple publishers. Likewise, the functions performed by the various entities of FIG. 2 may differ in different embodiments. Throughout the Specification, the terms “cross device identity matching service entity,” “cross device identity matching service,” “cross device identity matching service provider,” “identity matching service,” and “identity matching service provider” are used interchangeably to obtain different embodiments.

In FIG. 2, first, similar to FIG. 1, a request 211 is sent from the publisher 204 to an ad exchange 203 (and such request can be indirect, as discussed in conjunction with FIG. 1). Then, instead of the ad exchange sending the request to bidders as in FIG. 1, the ad exchange sends the request 212 to a cross device identity matching service 202. The cross device identity matching service 202 then looks up who this user is on a different device and sends the request 213 to the bidder 201 along with an extra valuable information: the bidder's ID (or DSP ID) on a different device.

With that extra valuable information, the bidders 201 can thus know more data about this user and can bid more confidently and more accurately. The bidders 201 send the bid requests 214 back to the cross device identity matching service 202 with bid prices, and the cross device identity matching service forwards the bid requests 217 to the ad exchange 203, and then similar to the FIG. 1, the ad exchange 203 runs the auction and decides the winner (e.g., the one with the highest price) and let the publisher 204 show the ad accordingly 218.

The value provided by the cross device identity matching service 202 is to tell the bidders 201 who this user is on a different device, so that the bidders 201 can utilize their known data of the same user on a different device. In at least one embodiment, the cross device identity matching service may be provided for companies with popular presences across multiple platforms/devices. For example, people use both the desktop web version of MySpace (myspace.com) on their PC/Mac and also MySpace mobile app on iPhone/Android/Windows phones. Similarly, people use the desktop version of Google services (e.g. google.com, gmail.com, etc.) on their PC/Mac, and people also use Android phones (which requires Google account login) or use Google's apps (e.g. Google Maps, Google Hangout, etc.) on non-Android mobile phones. Such service providers with popular presences across multiple platforms can be, but are not limited to, for example, Google, Facebook, Twitter, MySpace, Sina/Weibo, Apple, Microsoft/Skype, Amazon, eBay/PayPal, Dropbox, Pandora, etc. For the service providers/companies/social networks as mentioned above, a user may log in for both desktop web experience and mobile experience, and each user has a unique and uniform user id across multiple platforms/devices (e.g. MySpace user id, Google account, etc.), so that the service providers can bridge the gap between multiple devices and do cross device tracking. In an embodiment, the abovementioned service providers/companies/social networks can also help other entities (e.g. bidders) to bridge the gap between multiple devices, with an identity matching service.

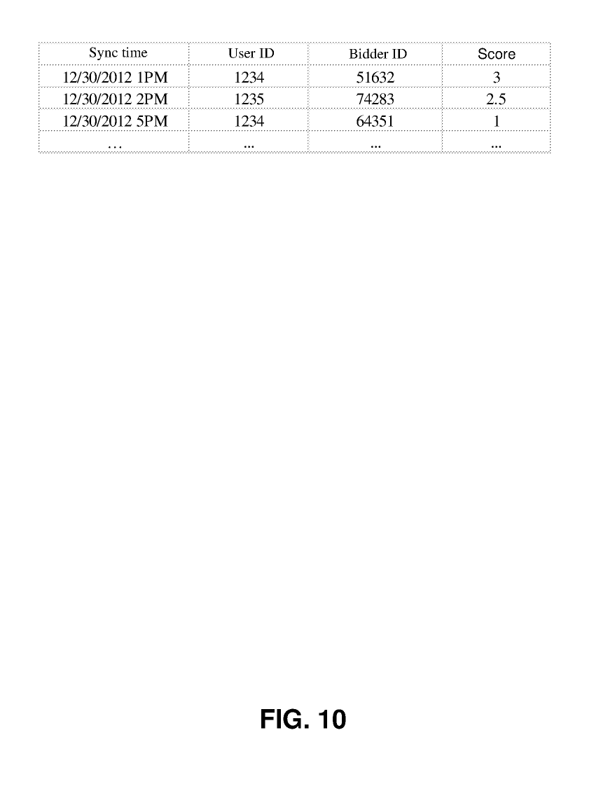

In an example, a user visited NORDSTROM.com and browsed a jacket (didn't buy or finish the transaction) on his/her laptop PC. Later, when the same user uses a mobile app (publisher, 204), e.g. Draw Something™, on his/her mobile device, an ad impression opportunity request is sent 211 to a mobile ad exchange 203. The mobile ad exchange then sends the request 212 to a cross device identity matching service 202. The cross device identity matching service 202 not only knows this user's user ID (e.g. MySpace could build a cross device identity matching service which knows user's MySpace ID), but also knows the bidder ID (DSP ID), e.g. TellApart ID, by maintaining the match table of bidder ID and user ID (as illustrated in FIG. 10). Thus, the cross device identity matching service can send the user's bidder ID on desktop (e.g. TellApart bidder ID on desktop) to a bidder (e.g. TellApart), so that the bidder (e.g. TellApart) can know this impression opportunity is from the same user who visited NORDSTROM.com earlier on desktop. Similarly, the device identity matching service 202 can send another bidder (e.g. Turn) the corresponding bidder ID (e.g. Turn ID) on desktop.

After the bidders 201 receive the requests 213 from the cross device identity matching service 202, they thus know the data of the user on desktop, which could be richer than the user's data on mobile. Thus, the bidders 201 send the bid requests back 214 to the cross device identity matching service 202, and the cross device identity matching service forwards the bid requests 217 to the mobile ad exchange 203. The mobile ad exchange 203 runs the auction and decides the winner of the ad impression and let the app Draw Something to display the corresponding ad 218. For example, if a bidder (e.g. TellApart) bids on behalf of Nordstrom and wins this impression, the ad can be for example the jacket the user browsed earlier on his/her PC. If the user clicks the ad in Draw Something, it will bring the user to the jacket product page on Nordstrom's mobile site, with the hope that the user can finish the transaction this time on his/her mobile device. The ad may also be an app install ad that if the user clicks the ad, it will bring the user to App Store to install the Nordstrom mobile app. In another example without retargeting, if another bidder (e.g. Turn) knows this user's car insurance will expire soon based on the user's desktop data (can be from the data the bidder owns, or can be from a 3^{rd} Party data provider, e.g. BlueKai™), the bidder bids on behalf of Progressive Insurance and wins this mobile impression, the ad shown to the user when the user plays Draw Something will be an ad from Progressive Insurance. Clicking on the ad will bring the user to a Progressive quote page to finish the insurance purchase or to the App Store to ask the user to install a Progressive Insurance app.

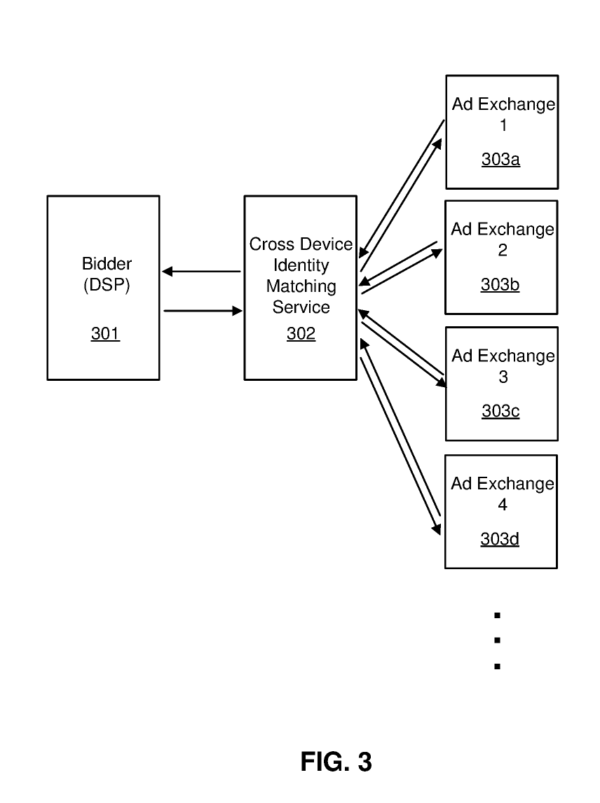

In the embodiment illustrated in FIG. 2, from the perspective of a bidder, the cross device identity matching service acts just like an ad exchange (or multiple ad exchanges if the cross device identity matching service connects to multiple ad exchanges, as illustrated in FIG. 3). The bidders receive the request from the cross device identity matching service 202 and send bid requests back to the cross device identity matching service 202, as if the cross device identity matching service is an ad exchange. If the cross device identity matching service 202 cannot find any other identities of the same user, the cross device identity matching service 202 will keep the identity information in the original request received from the ad exchange unchanged when forwarding the request to the bidders, as if the request is sent from the ad exchange 203 directly to the bidder 201.

In an embodiment, prior to forwarding the request from the ad exchange to the bidders, the cross device identity matching service 202 may replace the identity information with another identity of the same user on another device or on another browser when a match is found (e.g., a bidder ID associated with the same user on another device). For example, for an ad impression opportunity on mobile, the identity information in the request 212 from the ad exchange 203 can be an exchange ID, e.g. exchange ID 7657323, wherein the bidder will know the user's corresponding bidder ID on mobile, e.g. bidder ID 432783 ion mobile, when it receives the exchange ID 7657323 or when the ad impression is won by the bidder and shown. The ad exchange 203 may also maintain the match table of bidder ID (e.g. Turn ID) and exchange ID, by synchronizing bidder ID and exchange ID, so that the exchange can send the bidder ID 4327831 on mobile in the request 212 from ad exchange 203. In the earlier case (sending exchange ID in request 212), the ad exchange just needs to send one request to the cross device identity matching service 202 for each ad impression opportunity. In the later case (sending bidder ID in request 212), the ad exchange needs to send multiple requests (one for every bidder) to the cross device identity matching service 202 for each ad impression opportunity. In either case, the cross device identity matching service 202 can identify who this user is (e.g. this user's MySpace User ID is 46225457 if MySpace wants to build its identity matching service) and then can lookup and find the same user's other identities, e.g. this user's bidder ID is 5768322 on desktop.

The cross device identity matching service can replace the identity information from the original request 212 from the ad exchange 203 (exchange ID 4327831, or bidder ID 4327831 on mobile) with bidder ID 5768322 on desktop. The cross device identity matching service can choose to keep the original identity information and send both the original identity information (exchange ID 4327831, or bidder ID on mobile 4327831) and information of the matched identity (or multiple identities) of the same user (e.g. bidder ID 5768322 on desktop) to the bidder. But if sending both the original identity information and matched identity information, the bidder will thus know that bidder ID 5768322 on desktop and bidder ID 4327831 on mobile are the same user going forward. The bidder can thus remember these two IDs belong to the same user, and join this user's data on both web and mobile for any future bidding, on both web and mobile, on any ad exchanges, without the help of cross device identity matching service going forward, as long as any of the two bidder IDs is active. It is noted that there is a billing module (not shown in FIG. 2) inside the cross device identity matching service 202, and the cross device identity matching service can charge the bidder or the ad exchange by, for example, number of requests (or number of requests with at least another matched identity found) served to the bidder, or by a percent of the purchases the bidder spends using the service, or by number of impressions served using the service, etc. If the cross device identity matching service chooses to keep the original identity information and send both the original identity information and information of the matched identity, the service may not be able to keep track of the accurate numbers (number of requests, or spending, or number of impressions) using the service, because the bidder can remember the two identities are the same without the help of cross device identity matching service going forward.

In the embodiment illustrated in FIG. 2, the bidders 201 don't need to talk to the ad exchange 203 directly, because from the perspective of a bidder, the cross device identity matching service acts just as if it is an ad exchange, with the additional ability to support cross device identity matching. In some embodiments, the ad exchange 203 can still send requests 215 to bidders 201 directly, and the bidders can also send bid requests directly 216 to the ad exchange 203. But these two connections are not necessary. In some embodiments, the cross device identity matching service may not allow the ad exchange to send requests 215 directly to bidders. This is because if the bidder receives two similar requests at almost the same time with almost the same meta data, one from the cross device identity matching service 213 with matched identity (e.g. bidder ID on a different device, for example, bidder ID 5768322 on desktop), and another request from the ad exchange directly 215 with an original identity on the original device (The original identity information can be exchange ID 4327831, wherein bidder can know bidder ID 4327831 on original device based on this exchange ID 4327831; or the original identity information can be just bidder ID 4327831 on original device), the bidder can guess that the marched identity (e.g. bidder ID 5768322 on a different device) provided by the identity matching service, and the original identity (e.g. bidder ID 4327831 on original device) actually belong to the same user and can join the user's data on both web and mobile, and can utilize the joined data to bid on any exchanges without the help of cross device identity matching service going forward, as long as one of the two bidder IDs is still active. This may hurt the cross device identity matching service's ability to track its billing, similar to the aforementioned example of sending both the original identity information and information of the matched identity. However, this may still work if the bidder reports honestly, or the cross device identity matching service charges a relatively more expensive one-time cost for each cross device identity matching, instead of charging by number of requests/spending/number of impressions served.

FIG. 3 is a block diagram illustrating a real-time bidding eco-system, with the addition of cross device identity matching service entity. The publisher is not shown in FIG. 3 for simplicity. Also only one bidder 301, one cross device identity matching service 302 are shown in FIG. 3 to simplify and clarify the description. Implementations of the eco-system can have multiple bidders, multiple cross device identity matching services, multiple ad exchanges, and multiple publishers. Likewise, the functions performed by the various entities of FIG. 3 may differ in different embodiments.

The block diagram illustrated in FIG. 3 is an extension of FIG. 2, in which the cross device identity matching service connects to a lot of ad exchanges, or serves as an aggregation of multiple ad exchanges. The benefit of this embodiment is, for a specific bidder, as long as the bidder is connected to one cross device identity matching service, the bidder can already access to all the inventories on multiple ad exchanges. The bidder also enjoys the additional value (cross device identity matching ability) provided by the cross device identity matching service. It is noted that, a bidder can connect to multiple cross device identity matching services (e.g. one identity matching service run by one company, and another identity matching service run by another company), if they exist.

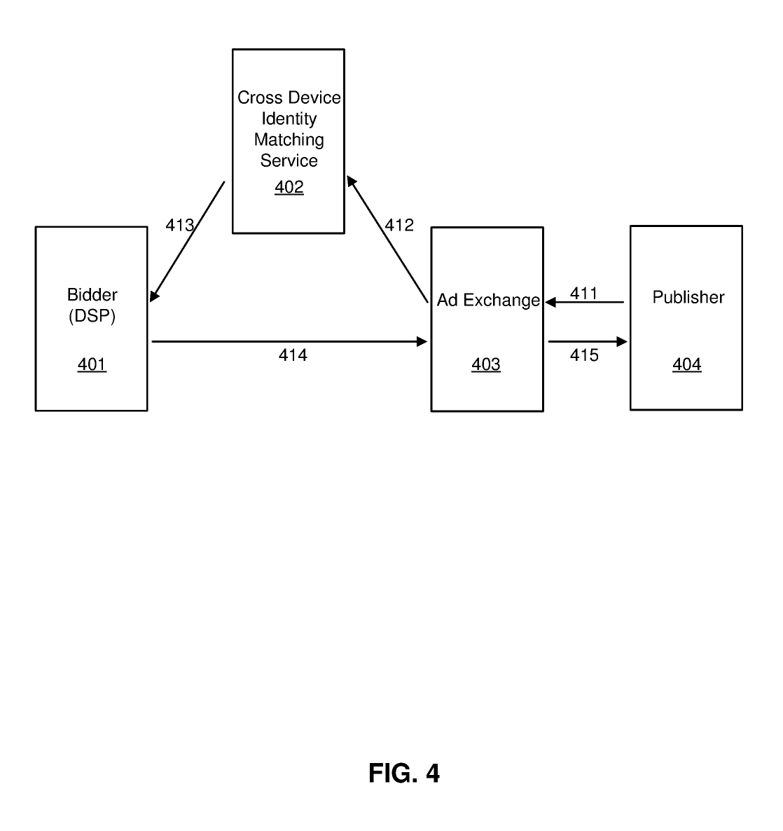

FIG. 4 to FIG. 8 are block diagrams illustrating real-time bidding eco-systems, with the addition of the cross device identity matching service, according to other embodiments. Only one bidder, one cross device identity matching service, one ad exchange, and one publisher are shown in FIG. 4 to FIG. 8 to simplify and clarify the description. Implementations of the eco-system can have multiple bidders, multiple cross device identity matching services, multiple ad exchanges, and multiple publishers. Likewise, the functions performed by the various entities of FIG. 4 to FIG. 8 may differ in different embodiments.

In the embodiment illustrated in FIG. 4 (a variant of FIG. 2), after the bidder gets a request 413, the bidder sends the bid request 414 directly to ad exchange instead of sending to the cross device identity matching service 402 to relay to the ad exchange 403. The benefit of this embodiment is that it saves one hop, making the process faster. The drawback of this embodiment is the identity matching service may thus lose its ability to do spending and impression number tracking but can still do request (the request from the cross device identity matching service to the bidder 413) number tracking.

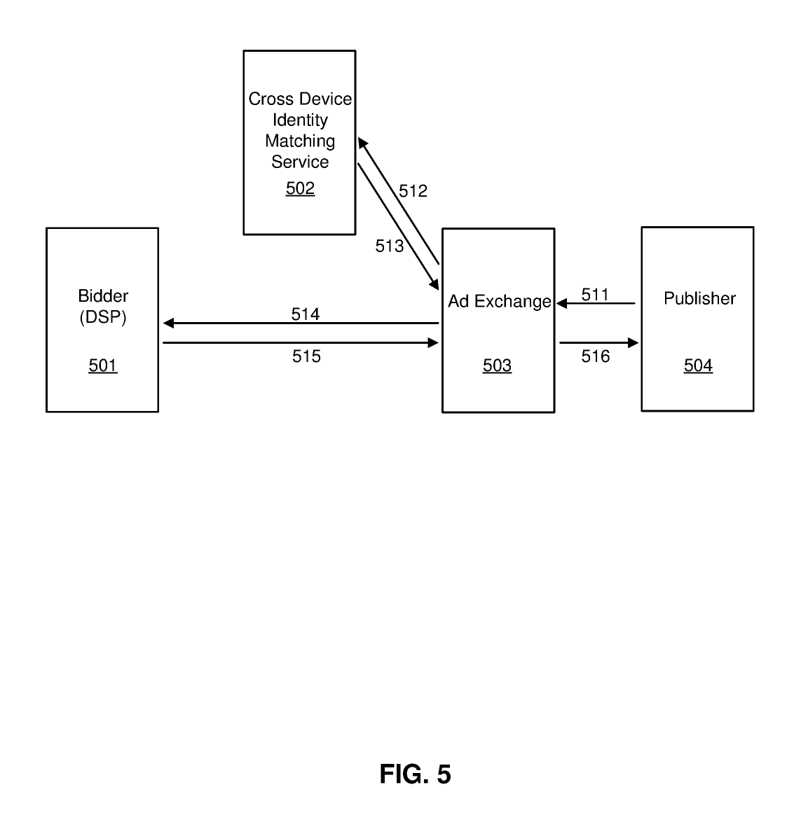

In the embodiment illustrated in FIG. 5 (also a variant of FIG. 2), the bidder connects to the ad exchange directly. Before the ad exchange sends the request 514 to a bidder, the ad exchange first communicates with (512, 513) the cross device identity matching service to ask for another identity of the same user (e.g. a bidder ID on a different device). Then the ad exchange then sends the request 514 to the bidder with the matched identity information (e.g. bidder ID on a different device). The request 514 may also contain the original identity information (e.g. exchange ID on the original device or bidder ID on the original device). In this embodiment, the cross device identity matching service may lose its ability to track the number of requests sent to bidders, the number of impressions served, and the bidders' spendings. In this embodiment, the exchange may remember the original identity and the matched identity actually belong to the same user going forward, without the help of cross device identity matching service.

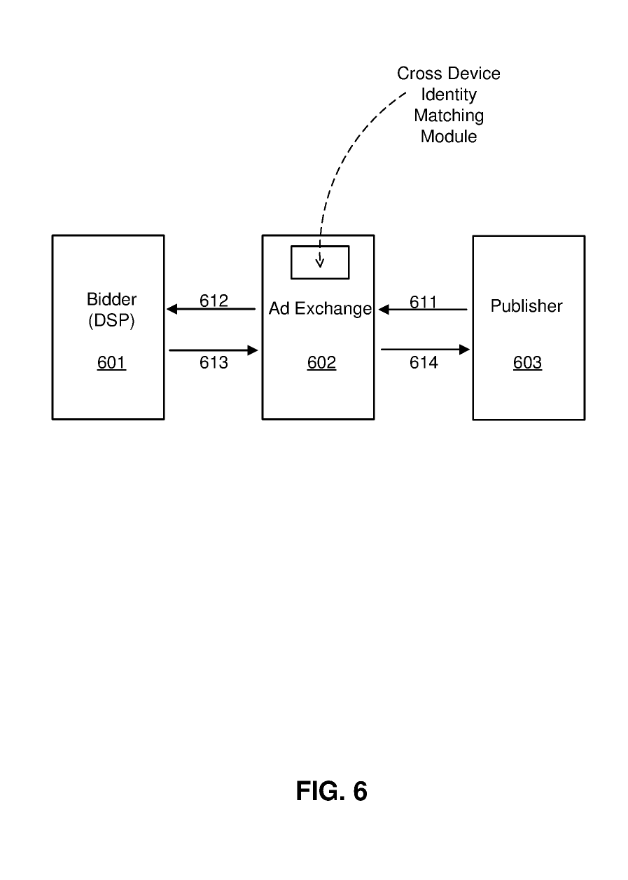

In all the embodiments of FIG. 2, FIG. 4 and FIG. 5, the cross device identity matching service and the ad exchange may be the same entity or have a parent, branch, subsidiary or affiliate relationship. For example, a company can own both a cross device identity matching service and an ad exchange. In the embodiment of FIG. 6, the cross device identity matching service is a module inside the ad exchange.

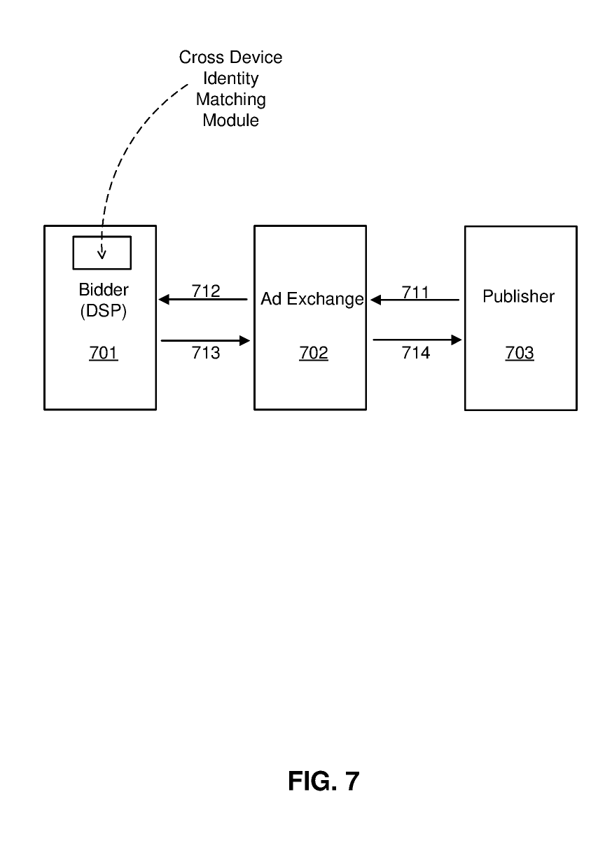

In all the embodiments of FIG. 2, FIG. 4, and FIG. 5, the bidder and the cross device identity matching service may be the same entity or have a parent, branch, subsidiary or affiliate relationship. For example, a company can own both a cross device identity matching service and a bidder. In the embodiment of FIG. 7, the cross device identity matching service is a module inside the bidder (or DSP).

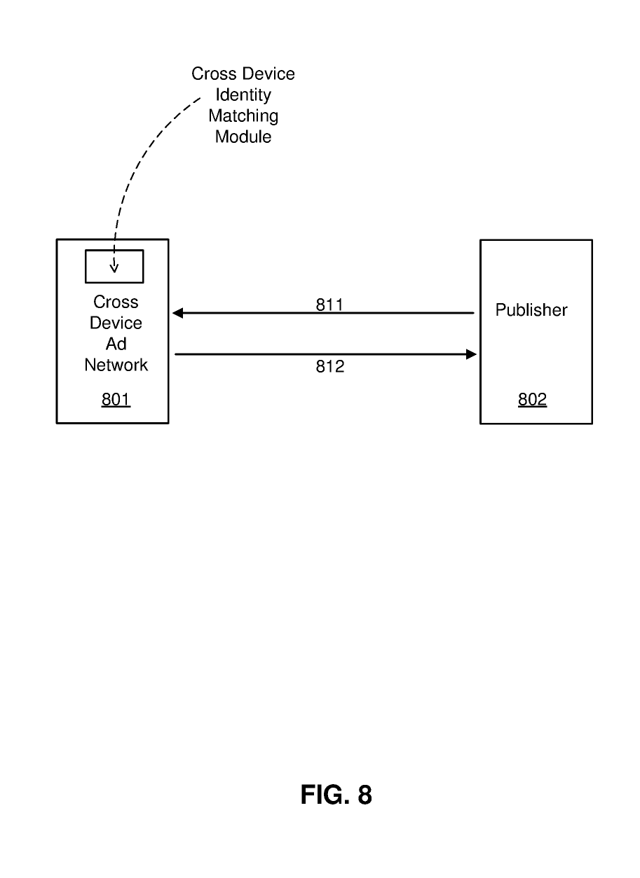

In all the embodiments of FIG. 2, FIG. 4, and FIG. 5, the bidder, the cross device identity matching service, and the ad exchange may be the same entity or have a parent, branch, subsidiary or affiliate relationship. For example, a company can own a cross device identity matching service, an ad exchange, and a bidder. In the embodiment of FIG. 8, the functionalities of bidder, cross device identity matching service and ad exchange are merged into one entity: cross device ad network, which has the cross device identity matching ability. If a cross device ad network is implemented, advertisers can use it to do cross device targeting (including cross device retargeting if they put cross device ad network company's tracking pixels), and the cross device ad network may have the access to each user's data across all devices (e.g. the user's all activities across PC/Mac, iPhone, Android phone, iPad, etc.), including the data that the cross device ad network company already owns (e.g. for MySpace: demographic information, interests, etc.).

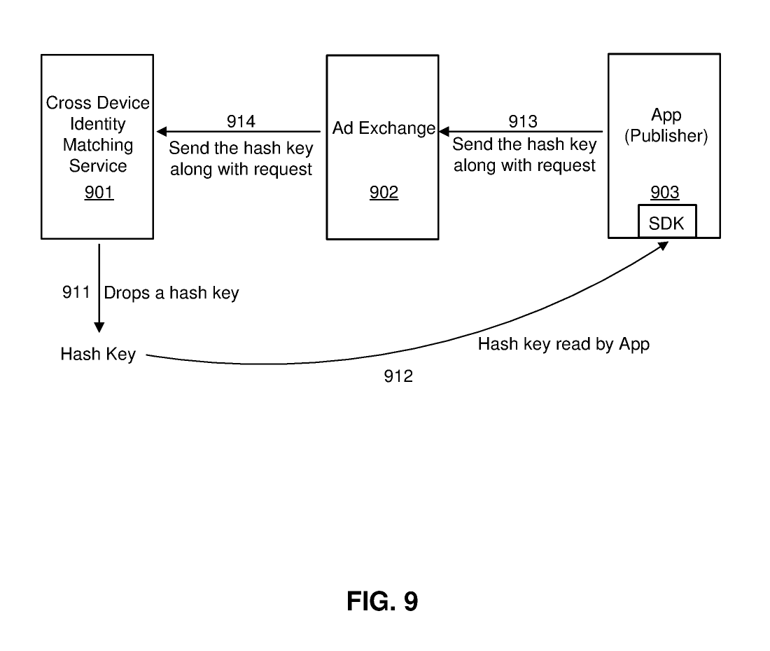

FIG. 9 is a block diagram illustrating how a cross device identity matching service identifies its unique and uniform user ID across multiple devices, according to one embodiment. Bidders and bid requests are not shown in FIG. 9 for simplicity. Only one cross device identity matching service, one app (publisher), and one ad exchange are shown in FIG. 9 to simplify and clarify the description. Implementations of the embodiment can have multiple cross device identity matching services, multiple apps (publishers), and multiple ad exchanges. Likewise, the functions performed by the various entities of FIG. 9 may differ in different embodiments.

In the embodiment illustrated in FIG. 9, first the cross device identity matching service 901 (or its parent, branch, subsidiary or affiliate entity) drops a file on the device, which contains a unique hash key (or unique number/ID). The key maybe be overwritten and updated on a regular basis (e.g. once every hour), and the cross device identity matching service 901 can always know the user's uniform user ID, given a hash key. The file containing the hash key is readable by any mobile apps (or desktop applications) on the device. When the user uses an app, which contains a SDK (software development kit) wherein the SDK can be provided by an ad exchange or an identity matching service, the app will read the hash key and pass the hash key to the ad exchange along with the request of ad impression opportunity, then when the ad exchange 902 sends the hash key along with the request 914 to the cross device identity matching service (also 212 in FIG. 2, or 412 in FIG. 4, or 512 in FIG. 5), the cross device identity matching service can know who this user is based on the hash key.

In a more concrete example, for illustration purposes, an identity matching service's main app (e.g. MySpace mobile app) on mobile (iPhone, iPad, Android phone, windows phone, etc.) can drop a file 911 which contains a unique hash key (or unique number) once every hour. Such file containing the hash key is readable from any app on the mobile device and its path/location is known/preset. For example, the hash key is 53DF9682339D4 an hour ago, and now the hash key is 9C9C2C292392E, both for MySpace user ID 46225457. Given the hash key 53DF9682339D4 or 9C9C2C292392E, MySpace will know the corresponding user is user ID 46225457. When the user uses an app (e.g. Draw Something) on the same mobile device, the app (publisher), which contains an SDK, will read 912 this hash key file, and will pass the hash key along with the request 913 of ad impression opportunity from the app (publisher) 903 to the ad exchange 902. In the request 914 from the exchange 902, to the cross device identity matching service 901, this hash key will be passed along as well. Thus, once the cross device identity matching service receives the hash key along with the request 914, it will know who the user is by looking up the hash key in the hash key table maintained by the identity matching service provider (or its parent, branch, subsidiary or affiliate entity). The hash key is only useful/meaningful for cross device identity matching service, because even if the ad exchange passes the key to the bidders, the bidders cannot know who this user is given the hash key. The ad exchange cannot know who this user is given the hash key either. Also since the hash key may keep changing periodically, even if a bidder or an ad exchange somehow knows it once and remembers the old hash key, the next time when a new hash key is written, the bidder or the ad exchange cannot recognize who this user is again given the new hash key. It is noted that the embodiment of FIG. 9 is one of the possible embodiments to allow the cross device identity matching service to identify its unique and uniform user ID across multiple devices without using cookies. The embodiment of FIG. 9 can be performed on a desktop device too.

FIG. 10 illustrates an example of match table's synchronizations. In this example, a bidder (or DSP), synchronizes with identity matching service, so that the identity matching service can know its each user's bidder ID (for example, if MySpace wants to build its identity matching service, MySpace can know each MySpace user's bidder ID(s), e.g. Turn ID(s), by syncing with a bidder). The synchronization can be achieved in a variety of ways (e.g. fires a pixel pointing to the bidder's domain, e.g. turn.com, and reads the bidder's cookie ID, and then redirect to the identity matching service's domain, e.g. myspace.com, while passing the bidder's ID in the query string). For simplicity, only identity matching service's user ID (e.g. MySpace user ID) and bidder ID are used for matching in the match table in FIG. 10. It is noted that, in some implementations, there may be another column which is identity matching service domain's cookie ID (e.g. myspace.com cookie ID). For example, for some bidders/DSPs that the identity matching service (e.g. the identity matching service run by MySpace if MySpace builds one) doesn't want to support cross device/cross browser matching, the identity matching service will only send those bidders their bidder ID(s) matched based on the identity matching service domain's cookie ID (e.g. myspace.com cookie ID) but not based on the identity matching service's user ID (e.g. MySpace user ID). In other words, for such bidders, the matching can be only done at the identity matching service domain's cookie ID level but not identity matching service's user ID level.

For bidders/DSPs that the identity matching service allows cross device (including cross browser) matching and retargeting, the identity matching service may ask these bidders not to put their own tracking pixel in the served impression, when a second identity (e.g. a cross device bidder ID) other than the original identity may be provided. If so, the bidder needs to rely on a 3^{rd} party (e.g. an ad serving company) for reporting/billing or trust the reporting/billing provided by identity matching service. This is because, for example, when an ad impression opportunity on device 1 (or browser 1) comes, and the identity matching service sends bidder ID on device 2 (or browser 2) to help the bidder do cross device targeting (which includes retargeting), if the bidder wins the impression and there is a bidder's tracking pixel in the shown ad, the bidder will know this user's bidder ID on device 1 (or browser 1) after the tracking pixel is fired upon rendering the ad impression. Thus, the bidder can remember that the two bidder IDs (one on device 1, another one on device 2 provided by the identity matching service) belong to the same user, and can use this knowledge for future opportunities on any ad exchanges going forward without the help of the identity matching service.

In each synchronization, the bidder can also tell the cross device identity matching service each bidder ID's score to indicate how much data that the bidder knows about each bidder ID, and to give a preference that which bidder ID to send when multiple bidder IDs are matched for the same user. The higher the score, the richer the data. For example, with the scores are provided, the identity matching service may send the matched bidder ID with the highest score that is synchronized within the last month (such time frame can be changed), or the identity matching service may send the matched bidder ID with certain probability, in which the higher the score, the higher the probability. In this case of FIG. 10, when the identity matching service's user ID 1234 is identified, both bidder ID 51632 and bidder ID 64351 are matched. For example, Bidder ID 51632 is the user's bidder ID on desktop with richer data (score 3) and bidder ID 64351 is the user's bidder ID on mobile with less data. The identity matching service will thus send bidder ID 51632 instead of bidder ID 64351 to the bidder (assuming request time is in January 2013 so that the time frame requirement is met), because the score of bidder ID 51632 is 3, which is higher than bidder ID 64351's score 1. In another example, the identity matching service may send bidder ID 51632 or bidder 64351 with certain probability, wherein bidder ID 51632 having higher probability because of higher score. On the other hand, for example, if a user always uses his/her mobile device but seldom uses his/her desktop, the data on mobile device will be richer, and the user's bidder ID on mobile will then be preferred.

Alternatively, without scores, the identity matching service can send the matched bidder IDs synchronized within last month (or a different time frame) in a round robin manner, which means when identity matching service's user ID 1234 comes, the identity matching service will send bidder ID 51632 with 50% chance and send bidder ID 64351 with 50% chance. Or, alternatively, the identity matching service may always send the latest synchronized bidder ID for a given identity matching service's user ID, which will be bidder ID 64351 for identity matching service's user ID 1234 in this case, given that bidder ID 64351's synchronization time was 5 pm, which is later than bidder ID 51632's 1 PM. It is also noted that identity matching service in this example can be run by any company with cross device tracking ability, including but not limited to, for example, Google, Facebook, Twitter, MySpace, Sina/Weibo, Apple, Microsoft/Skype, Amazon, eBay/PayPal, Dropbox, Pandora, etc., and the bidder in this example can be any bidders, including but not limited to, for example, Turn, TellApart, MediaMath, DataXu, RocketFuel, Criteo, etc.

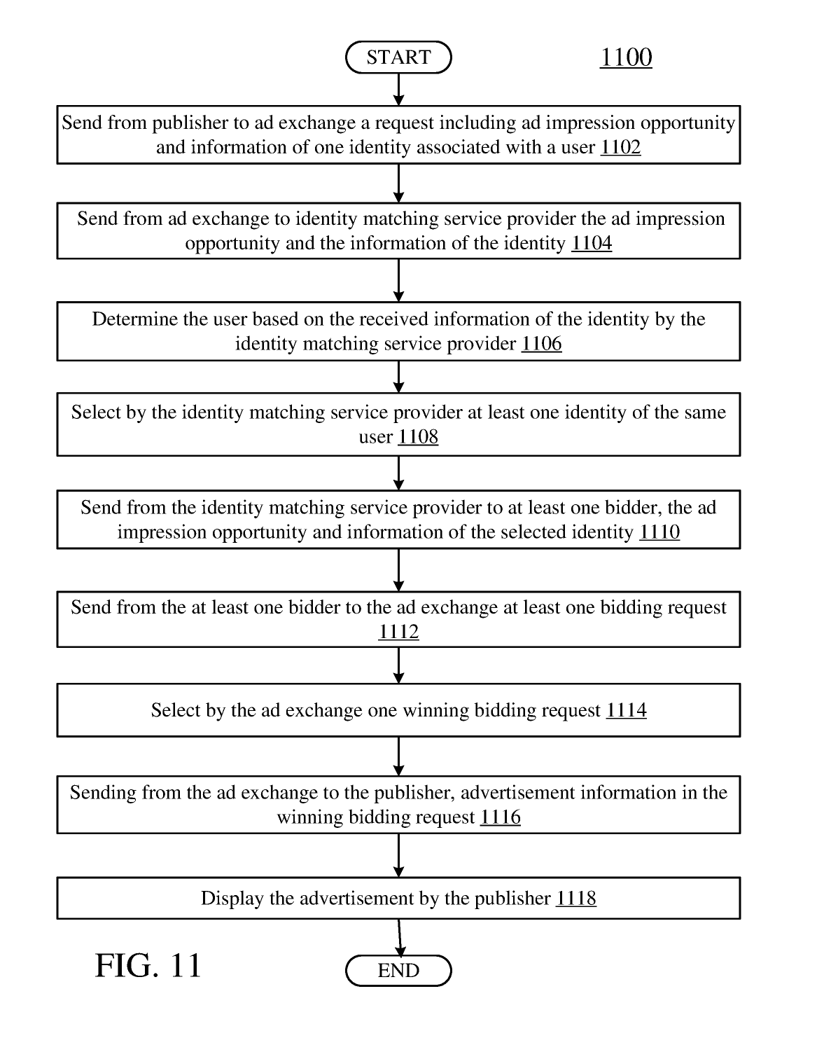

FIG. 11 shows a flowchart of an embodiment of a method 1100 of using the cross device identity match service for online advertising.

In step 1102, the publisher sends to the ad exchange a request including an ad impression opportunity and information of one identity associated with a user.

In step 1104, the ad exchange sends to the identity matching service provider the ad impression opportunity and the information of the identity.

In step 1106, the identity matching service provider determines the user based on the received information of the identity.

In step 1108, the identity matching service provider selects at least one identity of the same user. In an embodiment, each of the at least one identity is associated with a single computing device. In an embodiment, the identity selected by the identity matching service provider and the one identity that is sent by the ad exchange are associated with different computing devices.

In step 1110, the identity matching service provider sends to at least one bidder the ad impression opportunity and information of the identity selected by the identity matching service provider.

In step 1112, the at least one bidder sends to the ad exchange at least one bidding request.

In step 1114, the ad exchange selects one winning bidding request.

In step 1116, the ad exchange sends to the publisher advertisement information in the winning bidding request.

In step 1118, the publisher displays the advertisement.

In an embodiment, each of the steps of method 1100 is a distinct step. In another embodiment, although depicted as distinct steps in FIG. 11, steps 1102-1118 may not be distinct steps. In other embodiments, method 1100 may not have all of the above steps and/or may have other steps in addition to or instead of those listed above. The steps of method 1100 may be performed in another order.

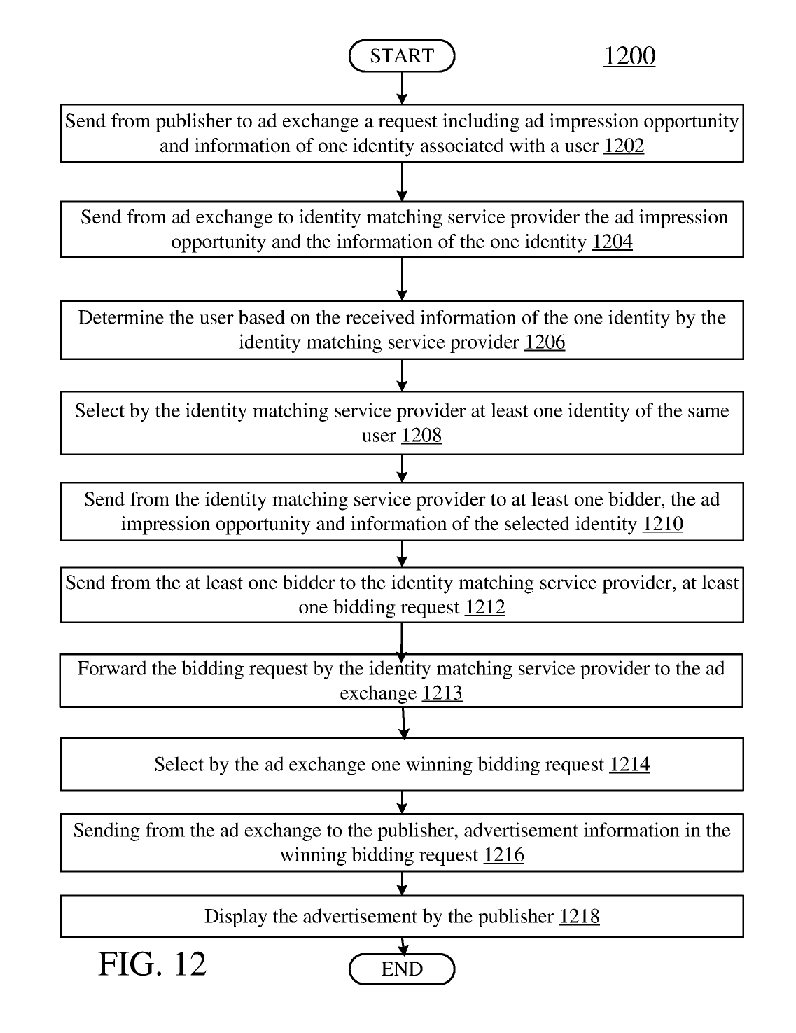

FIG. 12 shows a flowchart of an embodiment of a method 1200 of using the cross device identity match service for online advertising.

In step 1202, the publisher sends to the ad exchange a request including an ad impression opportunity and information of one identity associated with a user.

In step 1204, the ad exchange sends to the identity matching service provider the ad impression opportunity and the information of the identity.

In step 1206, the identity matching service provider determines the user based on the received information of the identity.

In step 1208, the identity matching service provider selects at least one identity of the same user. In an embodiment, each of the at least one identity is associated with a single computing device. In an embodiment, the identity selected by the identity matching service provider and the one identity that is sent by the ad exchange are associated with different computing devices.

In step 1210, the identity matching service provider sends to at least one bidder the ad impression opportunity and information of the identity selected by the identity matching service provider.

In step 1212, the at least one bidder sends to the identity matching service provider at least one bidding request.

In step 1213, the identity matching service provider forward the bidding request to the ad exchange.

In step 1214, the ad exchange selects one winning bidding request.

In step 1216, the ad exchange sends to the publisher advertisement information in the winning bidding request.

In step 1218, the publisher displays the advertisement.

In an embodiment, each of the steps of method 1200 is a distinct step. In another embodiment, although depicted as distinct steps in FIG. 12, steps 1202-1218 may not be distinct steps. In other embodiments, method 1200 may not have all of the above steps and/or may have other steps in addition to or instead of those listed above. The steps of method 1200 may be performed in another order.

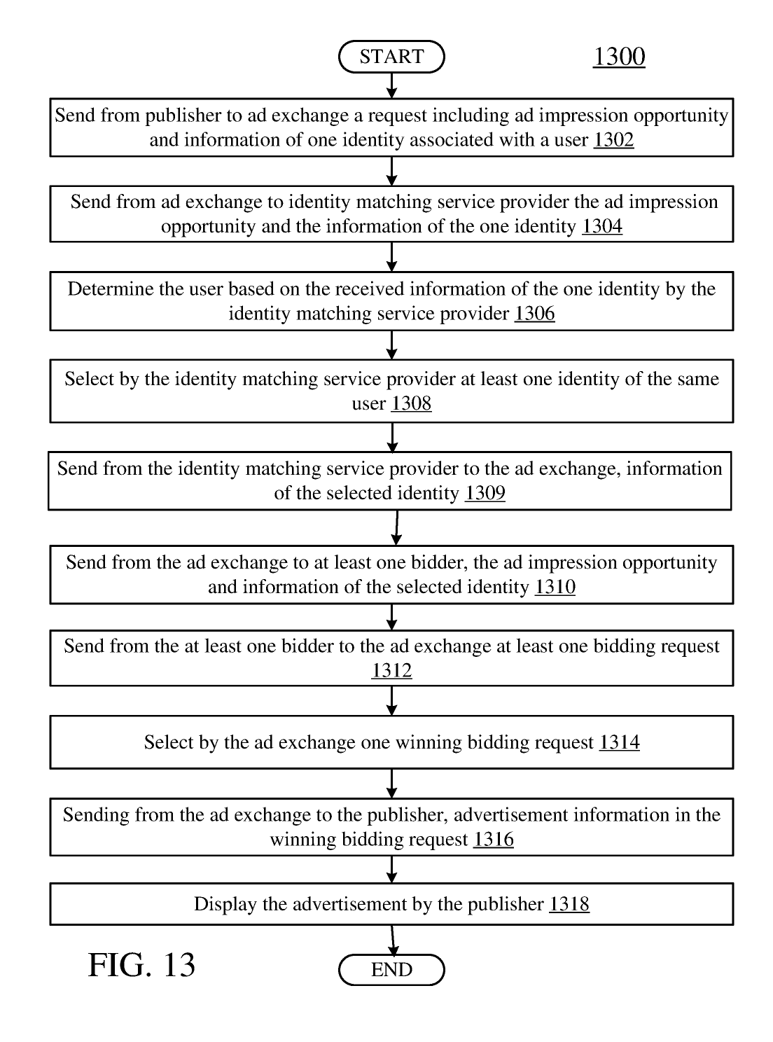

FIG. 13 shows a flowchart of an embodiment of a method 1300 of using the cross device identity match service for online advertising.

In step 1302, the publisher sends to the ad exchange a request including an ad impression opportunity and information of one identity associated with a user.

In step 1304, the ad exchange sends to the identity matching service provider the ad impression opportunity and the information of the identity.

In step 1306, the identity matching service provider determines the user based on the received information of the identity.

In step 1308, the identity matching service provider selects at least one identity of the same user. In an embodiment, each of the at least one identity is associated with a single computing device. In an embodiment, the identity selected by the identity matching service provider and the one identity that is sent by the ad exchange are associated with different computing devices.

In step 1309, the identity matching service provider sends information of the selected identity to the ad exchange.

In step 1310, the ad exchange sends to at least one bidder the ad impression opportunity and information of the identity selected by the identity matching service provider.

In step 1312, the at least one bidder sends to the ad exchange at least one bidding request.

In step 1314, the ad exchange selects one winning bidding request.

In step 1316, the ad exchange sends to the publisher advertisement information in the winning bidding request.

In step 1318, the publisher displays the advertisement.

In an embodiment, each of the steps of method 1300 is a distinct step. In another embodiment, although depicted as distinct steps in FIG. 13, steps 1302-1318 may not be distinct steps. In other embodiments, method 1300 may not have all of the above steps and/or may have other steps in addition to or instead of those listed above. The steps of method 1300 may be performed in another order.

### ALTERNATIVES AND EXTENSIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

What is claimed is:

1. A method, comprising:
sending, from a publisher to at least one ad exchange, a request that includes at least an advertisement (ad) impression opportunity and information of one identity associated with a user;
sending, from the at least one ad exchange to an identity matching service provider, the ad impression opportunity and the information of the one identity;
determining, by the identity matching service provider, the user based on the information of the one identity;
selecting, by the identity matching service provider, at least one identity of the same user, wherein each of the at least one identity is associated with a single one of at least one computing device; and
sending, from the identity matching service provider to at least one bidder, the ad impression opportunity and information of the at least one identity that is selected by the identity matching service provider.

2. The method of claim 1, wherein
the information of the one identity sent by the publisher is associated with a first computing device, and the at least one identity selected by the identity matching service provider is associated with at least a second computing device.

3. The method of claim 1, wherein
the information of the one identity sent by the publisher is associated with a same computing device with which the at least one identity selected by the identity matching service provider is associated.

4. The method of claim 1, the step of determining, by the identity matching service provider, the user based on the identity information further comprising
looking up user identity in a match table maintained by the identity matching service provider using the information of the one identity received from the ad exchange.

5. The method of claim 4, the step of selecting, by the identity matching service provider, at least one identity further comprising
selecting, from a plurality of identities associated with the same user in the match table, one of the plurality of identities that is associated with a highest score, wherein scores of the plurality of identities are provided by one bidder.

6. The method of claim 4, the step of selecting, by the identity matching service provider, at least one identity further comprising
selecting, from a plurality of identities associated with the same user in the match table, one of the plurality of identities that is most recently synchronized between one bidder and the identity matching service provider.

7. The method of claim 1, further comprising
looking up user in a match table maintained by the identity matching service provider using the information of the one identity received from the ad exchange, and
in response to a determination that no matching user is found in the match table, forwarding, by the identity matching service provider to the at least one bidder, the information of the one identity that is received from the ad exchange.

8. The method of claim 1, wherein
the information of the one identity that is sent from the ad exchange to the identity matching service provider includes a hash key,
the step of determining, by the identity matching service provider, the user based on the information of the one identity further including determining the user by looking up the hash key in a hash key table.

9. The method of claim 1, wherein
the identity matching service provider is included in the at least one ad exchange.

10. The method of claim 1, further comprising
sending, from the at least one bidder to the ad exchange, at least one bidding request, each of the at least one bidding request including at least a price and advertisement information;
selecting, by the ad exchange, one winning bidding request from the at least one bidding request; and
sending, from the ad exchange to the publisher, the advertisement information in the winning bidding request.

11. The method of claim 1, further comprising
sending, from the at least one bidder to the identity matching service provider, at least one bidding request, each of the at least one bidding request including at least a price and advertisement information; and
forwarding the at least one bidding request from the identity matching service provider to the ad exchange.

12. A method, comprising:
sending, from a publisher to at least one ad exchange, a request that includes at least an advertisement (ad) impression opportunity and information of one identity associated with a user;
sending, from the at least one ad exchange to an identity matching service provider, the ad impression opportunity and the information of the one identity;
determining, by the identity matching service provider, the user based on the information of the one identity;
selecting, by the identity matching service provider, at least one identity of the same user, wherein each of the at least one identity is associated with a single one of at least one computing device; and
sending, from the identity matching service provider to the at least one ad exchange, information of the at least one identity that is selected by the identity matching service provider.

13. The method of claim 12, further comprising
sending, from the at least one ad exchange to at least one bidder, the ad impression opportunity that is received from the publisher together with the information of the at least one identity selected by the identity matching service provider.

14. The method of claim 12, further comprising
sending, from the at least one ad exchange to at least one bidder, the information of the one identity and the ad impression opportunity that are received from the publisher together with the information of the at least one identity selected by the identity matching service provider.

15. A method, comprising:
sending, from a publisher to at least one ad exchange, a request that includes at least an advertisement (ad) impression opportunity and information of a first identity;
sending, from the at least one ad exchange to an identity matching service provider, the ad impression opportunity and the information of the first identity;
determining the user based on the information of the first identity by the identity matching service provider;
selecting, by the identity matching service provider, a second identity of the same user; and
sending, from the identity matching service provider to at least one bidder, the ad impression opportunity and information of the second identity.

16. The method of claim 15, the step of selecting, by the identity matching service provider, a second identity further comprising
selecting, by the identity matching service provider, a plurality of identities of the same user, wherein each of the plurality of identities is associated with a single one of a plurality of computing devices, wherein the second identity is different from the first identity and the second identity is one of the plurality of identities of the same user.

17. The method of claim 15, further comprising
receiving, at the ad exchange or the identity matching service provider from the plurality of bidders, a plurality of bidding requests, each of the plurality of bidding requests including at least a price and advertisement information;
comparing, by the ad exchange, the plurality of bidding requests;
selecting, by the ad exchange, one winning bidding request from the plurality of bidding requests; and
sending, from the ad exchange to the publisher, the advertisement information in the winning bidding request.

18. A method, comprising:
sending, from a publisher to at least one ad exchange, a request that includes at least an advertisement (ad) impression opportunity and information of a first identity;
sending, from the at least one ad exchange to an identity matching service provider, the ad impression opportunity and the information of the first identity;
determining the user based on the information of the first identity by the identity matching service provider;
selecting, by the identity matching service provider, a second identity of the same user; and
sending, from the identity matching service provider to the at least one ad exchange, information of the second identity.

19. The method of claim 18, further comprising
sending, from the at least one ad exchange to at least one bidder, the ad impression opportunity that is received from the publisher together with the information of the second identity selected by the identity matching service provider.

20. A method, comprising:
sending, from a publisher to at least one ad exchange, a request that includes at least an advertisement (ad) impression opportunity and information of a first identity associated with a first computing device;
sending, from the at least one ad exchange to an identity matching service provider, the ad impression opportunity and the information of the first identity;
determining the user based on the information of the first identity by the identity matching service provider; and
selecting, by the identity matching service provider, a second identity of the same user, the second identity being associated with a second computing device.

21. The method of claim 20, the step of selecting, by the identity matching service provider, a second identity further comprising
selecting, by the identity matching service provider, a plurality of identities of the same user, wherein each of the plurality of identities is associated with a single one of a plurality of computing devices other than the first computing device, the second identity being one of the plurality of identities of the same user.

22. A method, comprising
receiving, at an identity matching service provider from at least one ad exchange, at least one request that includes at least an advertisement (ad) impression opportunity and information of one identity that is associated with a user;
determining, by the identity matching service provider, the user based on the information of the one identity received from the at least one ad exchange;
selecting, by the identity matching service provider, at least one identity of the same user; and
sending, from the identity matching service provider to at least one bidder or the at least one ad exchange, at least information of the at least one identity that is selected by the identity matching service provider.

23. An identity matching service provider, comprising at least
a processor system having at least a processor,
a communication interface,
a memory system storing one or more machine instructions on one or more non-transitory computer readable media; and
wherein the one or more machine instructions, when implemented, cause the processor system of the identity matching service provider to implement a method including at least
receiving, at the identity matching service provider from at least one ad exchange, at least one request that includes at least an advertisement (ad) impression opportunity and information of one identity that is associated with a user;
determining, by the identity matching service provider, the user based on the information of the one identity received from the at least one ad exchange;
selecting, by the identity matching service provider, at least one identity of the same user; and
sending, from the identity matching service provider to at least one bidder or the at least one ad exchange, at least information of the at least one identity that is selected by the identity matching service provider.
